(19) United States
(12) Patent Application Publication
(10) Pub. No.: US 2009/0091065 A1
(43) Pub. Date: Apr. 9, 2009

(54) Electrospinning Apparatus For Producing Nanofibers and Process Thereof

(75) Inventors: Dhirendra S. Katti, Kanpur (IN); Riju Mohan Singhal, Kanpur (IN); Amit Nandan, Kanpur (IN)

Correspondence Address: REINHART BOERNER VAN DEUREN P.C., 2215 PERRYGREEN WAY, ROCKFORD, IL, 61107, US

(73) Assignee: Indian Institute of Technology Kanpur, Kanpur (IN)

(21) Appl. No.: 12/246,744

(22) Filed: Oct. 7, 2008

(30) Foreign Application Priority Data
Oct. 9, 2007 (IN) 2112/DEL/2007

(51) Int. Cl. B29C 47/00; B29C 47/08

(52) U.S. Cl. 264/465; 425/66

(57) ABSTRACT

The present disclosure provides an electrospinning apparatus for producing aligned and crossed nanofibers and method of electrospinning using said apparatus to produce aligned and crossed nanofibers. The electrospinning apparatus comprises of a supported horizontal surface; a DC motor placed below the horizontal surface, a circular rotating disc attached to the DC motor by means of shaft which rotates said disc; a reservoir with an electrospinning element having at least one tip placed perpendicularly above the disc surface, said electrospinning element has a passage by which a substance from which the nanofibers are to be composed is provided to an interior of the tip of the electrospinning element, said electrospinning element configured to electrospin said nanofibers by high voltage mediated extraction of the substance from the tip of the electrospinning element; and at least a focusing device that is positioned exactly below the electrospinning element tip configured to focus the electrospun nanofibers by manipulating the electric field and the disc surface for focusing the electrospun nanofibers into a defined region on the disc surface. The electrospinning element and the focusing device are connected to the opposite terminals of an external high voltage (DC) power supply and face exactly opposite each other.

### CROSS-REFERENCE TO RELATED PATENT APPLICATIONS

This patent application claims the benefit of Indian Patent Application No. 2112/DEL/2007, filed Oct. 9, 2007, the entire teachings and disclosure of which are incorporated herein by reference thereto.

### FIELD OF INVENTION

The present disclosure provides an electrospinning apparatus for producing aligned and crossed nanofibers and method of electrospinning to produce said aligned and crossed nanofibers thereof.

### BACKGROUND AND PRIOR ART

With rapid advances in the field of nanotechnology, nanofibers have been found to be useful in a variety of applications such as filter media, protective clothing and biomedical applications.

One of the biomedical applications includes their usage as tissue engineering scaffolds. Tissue Engineering approaches generally involve the use of biodegradable scaffolds that are meant to mimic the Extracellular matrix (ECM) by providing a structural support and surface for cells to attach on and grow. Cell migration, proliferation and differentiation functions are dependent on cell adhesion for many cell types. It has been suggested that surfaces with high surface area to volume ratio provide enhanced cell adhesion. Nanofibers offer a high surface area to volume ratio, high porosity, flexibility in surface functionalities and superior mechanical properties (tensile strength), thereby making them good candidates for scaffolds in tissue engineering. The mesh of structural protein (collagen) fibers of the ECM, which gives strength and elasticity to the tissue, has fibril/fiber diameters ranging from 1.5 nm to 20 μm. Further, it has been reported, that cells attach to and organize around fibers with diameters smaller than those of cells (cell diameters are in the range of microns). Therefore, to mimic the natural ECM as closely as possible electrospun polymeric nanofibers can be a useful scaffolding system for tissue engineering.

Studies involving cells seeded on scaffolds with aligned fibers have demonstrated that the cells tend to attach and migrate along the axis of the aligned nanofibers. According to the “contact guidance theory”, a cell has maximum probability of migrating in directions that are associated with chemical, structural, and mechanical properties of the substratum i.e. the scaffold. In blood vessels, circumferential orientation in smooth muscle cells is believed to provide the blood vessels the mechanical strength required to withstand the inner pressure of blood. If the fibers forming the scaffold are better aligned, they allow greater control of cell growth. For example, in case of a coronary-artery graft, smooth muscle cells could be grown on a nanofiber scaffold with inherent alignment that mimics an artery. This could lead to improved rates of vascular-tissue regeneration and improved probability of long-term success of the vascular graft. Similarly, some other tissues that could benefit from the alignment in scaffolds are cardiac, muscle, ligament and neural tissue. Therefore, in this context it seems desirable to devise methods for the productions of aligned nanofibers which can serve as a functional scaffold.

Various experimental parameters have been manipulated and worked upon to influence the natural pattern of electrospun nanofibers so as to achieve desired patterns. Smith et al reported a technique for alignment of metallic nanowires (gold, Au, nanowires) using an electric field. The nanowires are aligned in a dielectric medium between two electrodes defined lithographically on a SiO₂ substrate. Tanase et al disclosed an approach for magnetic field assisted alignment of nickel nanowires (prepared by electrochemical growth in alumina templates). The nanowires were shown to respond to external magnetic fields. These wires were suspended in a viscous medium and an external filed was applied resulting in their alignment. Huang et al presented a strategy for assembling a suspension of nanowires in parallel arrays by combining fluidic alignment (using fluidic channels) with surface patterning techniques. Smit et al reported a method for producing aligned electrospun yarns. The fibers were collected on a liquid collector while one of their ends was attached to a roller rotating at a speed of 0.05 m/s. This method can be used for producing continuous aligned fiber yarns. Kameoka et al reported alignment of electrospun nanofibers using a scanning tip as carrier for polymer solution and a rotating substrate. Theron et al, employed the edge of a rotating metallic disc as the anti-electrode to converge electrospun fibers. Further, the disc edge was placed directly below the syringe needle to collect the electrospun fiber.

U.S. Pat. No. 4,689,186 describes the formation of tubular products by depositing electrospun nanofibers on a charged rotating mandrel. An auxiliary electrode is also used here which distorts the electric field around the collector so that a large majority of fibers are deposited circumferentially on the mandrel. The auxiliary electrode has the same charge as the collector and has a potential which is smaller then the collector. It can have various geometries and for the purpose of illustration, the authors have demonstrated an auxiliary electrode in the form a grid composed of steel rods arranged parallel to each other. Similarly, U.S. Pat. No. 4,323,525 discusses a method for depositing electrospun nanofibers on a rotating mandrel. The collector is a conducting sheath wrapped around the rotating mandrel from which the spun tubular product can later be removed. U.S. Pat. No. 7,134,857 describes the use of a modified electrode-anti-electrode arrangement with low (1.5 cm) separation between them. The collector is the inner surface of a cylinder maintained at ground potential. The arrangement for rotating both the electrode and the substrate is provided. The effect of relative angular velocity of the electrodes on alignment is also studied and it is shown that increasing the relative velocity between the substrate and electrode increases the alignment of the electrospun nanofibers. U.S. Pat. No. 4,552,707 describes the synthesis of vascular grafts fabricated by collecting electrospun fibers on a rotating mandrel (mandrel diameter varies from 1 mm to 20 mm) wherein the degree of anisotropy of the depositing fibers is dependent on the speed of rotation of the mandrel. The mandrel itself serves as the anti-electrode and its speed of rotation was varied between 0 to 25,000 rpm. The mechanical properties of the vascular grafts so obtained have been demonstrated to vary with mandrel speed.

### SUMMARY

The present disclosure provides an electrospinning apparatus for producing aligned and crossed nanofibers, said apparatus comprising, a supported horizontal surface; a DC motor attached below the horizontal surface, wherein a circular rotating disc is attached to the DC motor by means of shaft which rotates said disc; a reservoir with an electrospinning element placed perpendicularly above said disc's top surface, said electrospinning element having at least a tip, said electrospinning element having a passage by which a substance from which the nanofibers are to be composed is provided to an interior of said tip of the electrospinning element, and said electrospinning element configured to electrospin said nanofibers by a high voltage mediated extraction of the substance from said tip of the electrospinning element; and at least a focusing device positioned longitudinally below the electrospinning element tip for focusing the electrospun nanofibers into a defined region on said disc's top surface, wherein said focusing device is placed exactly below said tip of the electrospinning element and below said disc's bottom surface, said focusing device having axis perpendicular to said disc, said focusing device configured to focus the electrospun nanofibre by electric field, wherein said electrospinning element and said focusing device are connected to the opposite terminals of an external high voltage (DC) power supply.

The present disclosure provides a method of electrospinning to produce electrospun nanofibers by employing the apparatus, said method comprising; introducing a potential difference between an electrospinning element and a focusing device for focusing said electrospun nanofibers by an external high voltage (DC) power supply; positioning a circular disc in between said electrospinning element and said focusing device and connecting said disc to a DC motor by means of shaft which rotates said disc, drawing a substance from which the nanofibers are to be composed from said reservoir by means of said tip of the electrospinning element towards said focusing device for focusing the electrospun nanofibers into a defined region on said disc's top surface positioned longitudinally below said electrospinning element tip, said region is coated with a non-conducting substrate; and collecting said substance as electrospun nanofiber on the said region of said disc surface at position exactly longitudinally above said focusing device, wherein said electrospun nanofiber is in aligned form, and optionally discontinuing said power supply; rotating said non-conducting substrate by 90°; and re-introducing said power supply to obtain said aligned electrospun nanofiber on said non-conducting substrate coated over said disc surface in crossed form.

### BRIEF DESCRIPTION OF DRAWINGS

FIG. 1 is an Electrospinning apparatus for synthesizing aligned and cross polymeric nanofibers

FIG. 2 is an Inverted envelope cone formed in the presence of two oppositely charged needles that act as electrode and anti-electrode.

FIG. 3(a) to (d) are Scanning Electron Micrographs of nanofibers obtained using 15% polystyrene (PS) solution taken at four different radial distances on the circulating disc surface (7 cm, 9 cm, 11 cm and 13 cm) while rotating the disc at 1500 rpm and keeping the inter-electrode distance fixed at 5 cm. The applied voltage between the oppositely charged needles was 15 kV for all the four radial distances.

FIG. 4 is a Scanning Electron Micrographs of nanofibers obtained using 18% polystyrene (PS) solution taken at four different radial distances (7 cm, 9 cm, 11 cm and 13 cm) while rotating the disc at 1500 rpm and keeping the distance between the oppositely charged needles fixed at 5 cm. The applied voltage between the oppositely charged needles was 15 kV for all the four radial distances.

FIG. 5(a) to (d) are Scanning Electron Micrographs of nanofibers obtained using 20% polystyrene (PS) solution taken at four different radial distances (7 cm, 9 cm, 11 cm and 13 cm) while rotating the disc at 1500 rpm and keeping the distance between the oppositely charged needles fixed at 5 cm. The applied voltage between the oppositely charged needles was 15 kV for all the four radial distances.

FIG. 6(a) to (f) are Scanning Electron Micrographs of nanofibers obtained using 15% polystyrene (PS) solution taken at six different potential differences (7, 8, 12, 14, 18 and 22 kV) while rotating the disc at 1500 rpm and keeping the radial distance fixed at 10 cm. The distance between the oppositely charged needles was 5 cm.

FIG. 7(a) to (f) are Scanning Electron Micrographs of nanofibers obtained using 18% polystyrene (PS) solution taken at six different potential differences (7, 8, 12, 14, 18 and 22 kV) while rotating the disc at 1500 rpm and keeping the radial distance fixed at 10 cm. The distance between the oppositely charged needles was 5 cm.

FIG. 8(a) to (f) are Scanning Electron Micrographs of nanofibers obtained using 20% polystyrene (PS) solution taken at six different potential differences (7, 8, 12, 14, 18 and 22 kV) while rotating the disc at 1500 rpm and keeping the radial distance fixed at 10 cm. The distance between the oppositely charged needles was 5 cm.

FIG. 9(a) to (c) are Scanning Electron Micrographs of cross nanofibers obtained using 18% polystyrene (PS) solution at a radial distance of 13 cm under a applied potential difference of 7 kV. The distance between the oppositely charged needles was 5 cm and the disc was rotated at 1500 rpm.

In all the figures ‘R’ denotes the radial distance at which the fibers are collected while ‘VD’ denotes the distance between the oppositely charged needles.

### DETAILED DESCRIPTION

The present disclosure provides an electrospinning apparatus for producing aligned and crossed nanofibers and method of electrospinning to produce aligned and crossed nanofibers thereof.

In an embodiment, the present disclosure provides a supported horizontal surface; a DC motor fitted below the horizontal surface, wherein a circular rotating disc is attached to the DC motor by means of shaft which rotates the disc; a reservoir with an electrospinning element is placed perpendicularly above the disc surface, said electrospinning element having at least one tip, said electrospinning element having a passage by which a substance from which the nanofibers are to be composed is provided to an interior of the tip of the electrospinning element, and said electrospinning element configured to electrospin said nanofibers by high voltage mediated extraction of the substance from the tip of the electrospinning element; and at least a focusing device positioned longitudinally below the electrospinning element tip for focusing the electrospun nanofibers into a defined region on the disc surface, wherein said focusing device is placed exactly below the tip of the electrospinning element and below the disc surface and having axis perpendicular to said disc, said focusing device is configured to focus the electrospun nanofibers by electric field. The electrospinning element and the focusing device are connected to the opposite terminals of an external high voltage power supply (DC) and acts as an electrode and an anti-electrode respectively.

In an embodiment, the present disclosure provides an electrospinning apparatus enclosed in a Plexiglas enclosure.

In an embodiment, the present disclosure provides an electrospinning apparatus where the reservoir is a piston-reservoir system or glass syringe with a glass plunger.

In an embodiment, the present disclosure provides an electrospinning apparatus where the electrospinning element is a blunt capillary needle having inner diameter of about 0.3 mm to about 1 mm, preferably about 0.4 to 0.6 mm.

In an embodiment, the present disclosure provides an electrospinning apparatus where the electrospinning element is a metallic needle.

In an embodiment, the present disclosure provides an electrospinning apparatus where the reservoir with an electrospinning element is a scanning tip dipped in the substance from which the nanofibers are composed. The scanning tip is a made of metallic substance such as a stainless steel needle.

In an embodiment, the present disclosure provides an electrospinning apparatus where the focusing device for focusing the electrospun nanofibers is a needle.

In an embodiment, the present disclosure provides an electrospinning apparatus where the needle is a metallic material.

In an embodiment, the present disclosure provides an electrospinning apparatus where the electrospinning element and said disc are at a distance ranging from about 4 cm to about 10 cm.

In an embodiment, the present disclosure provides an electrospinning apparatus where said disc is made of material having low dielectric constant.

In an embodiment, the present disclosure provides an electrospinning apparatus where said disc is made of wood and having thickness ranging from about 1 mm to about 3 mm.

In an embodiment, the present disclosure provides an electrospinning apparatus where said disc is having radius of about 5 cm to 20 cm, preferably about 13 to 15 cm.

In an embodiment, the present disclosure provides an electrospinning apparatus where the position of the said defined region on the disc surface where the electrospun nanofiber is focused ranges from a radius of about 7 cm-about 13 cm.

In an embodiment, the present disclosure provides an electrospinning apparatus where the DC motor rotates said disc at a speed ranging from about 1000 rpm to about 2000 rpm.

In an embodiment, the present disclosure provides an electrospinning apparatus where the DC motor rotates said disc at 1500 rpm.

In an embodiment, the present disclosure provides an electrospinning apparatus where the aligned and crossed nanofibers are used in biomedical applications such as wound dressing.

In still another embodiment, the present disclosure provides an electrospinning apparatus where the aligned and crossed nanofibers are used in applications related to filter media.

In still another embodiment, the present disclosure provides an electrospinning apparatus where the aligned and crossed nanofibers are used as scaffolds in tissue engineering applications.

In another embodiment, the present disclosure provides a method of electrospinning to produce aligned nanofibers by employing said electrospinning apparatus, said method comprising; introducing a potential difference between the electrospinning element and the focusing device for focusing said electrospun nanofibers by an external high voltage power supply; drawing a substance from which the nanofibers are to be composed from said reservoir by means of/through said tip of the electrospinning element towards the focusing device for focusing the electrospun nanofibers into a defined region on the disc surface positioned longitudinally below the electrospinning element tip, and collecting said substance as electrospun nanofiber in aligned form on said disc surface at a position exactly longitudinally above said focusing device.

In another embodiment, the present disclosure provides a method of electrospinning to produce crossed nanofibers by employing said electrospinning apparatus, said method comprising; introducing a potential difference between the electrospinning element and the focusing device for focusing said electrospun nanofibers by an external high voltage power supply; drawing a substance from which the nanofibers are to be composed from said reservoir by means of/through said tip of the electrospinning element towards the focusing device for focusing the electrospun nanofibers into a defined region on the disc surface positioned longitudinally below the electrospinning element tip, and collecting said substance as electrospun nanofiber in aligned form on another non-conducting substrate (plastic tape) placed on the said disc surface at a position exactly longitudinally above said focusing device, discontinuing said power supply and rotating the non-conducting substrate (plastic tape) placed on said disc surface by 90°; and re-introducing said power supply to obtain aligned electrospun nanofiber on said disc surface in crossed form.

In another embodiment, the present disclosure provides a method of electrospinning to produce aligned and crossed nanofibers by employing said electrospinning apparatus where the aligned nanofiber forms concentric rings having fiber diameter ranging from about 800 nm to about 1200 nm.

In another embodiment, the present disclosure provides a method of electrospinning to produce aligned and crossed nanofibers by employing said electrospinning apparatus where the substance is a polymeric material that can either be a homopolymer, a copolymer or a blend of polymers.

In another embodiment, the present disclosure provides a method of electrospinning to produce aligned and crossed nanofibers by employing said electrospinning apparatus where the substance is a polymeric material selected from a group consisting of polystyrene, poly(lactic acid), poly(lactide-co-glycolide), chitosan, gelatin, polyvinyl alcohol, polyaniline (PANI)/PEO blend, polyurethanes, polyethylene-co-vinyl acetate, polycaprolactone, PCL, polyethylene glycol, poly(ethylene-co-vinyl alcohol), chitin, collagen, collagen-PEO, silk, silk/PEO blend and hyaluronic acid.

In another embodiment, the present disclosure provides a method of electrospinning to produce aligned and crossed nanofibers by employing said electrospinning apparatus where the defined region on the disc surface where the electrospun fiber are focused and collected ranges from radius about 7 cm to about 13 cm.

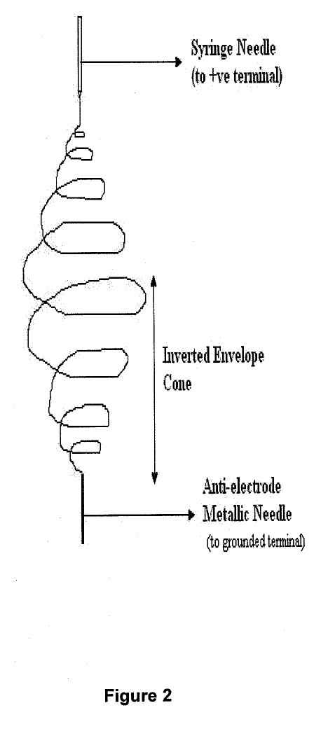

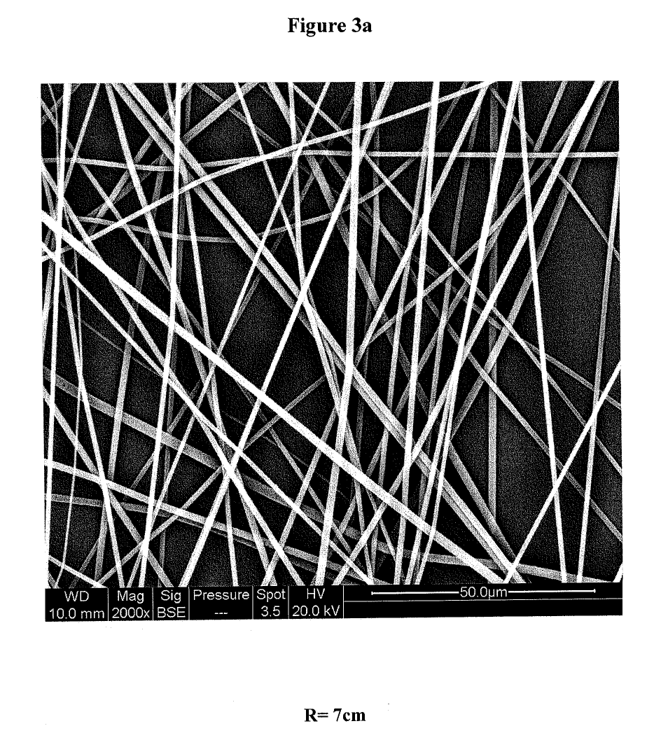

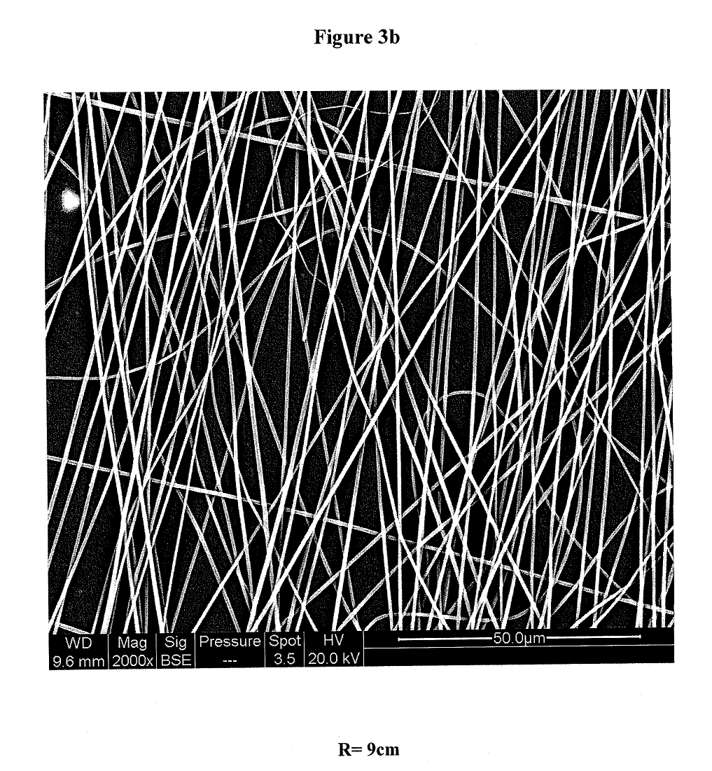

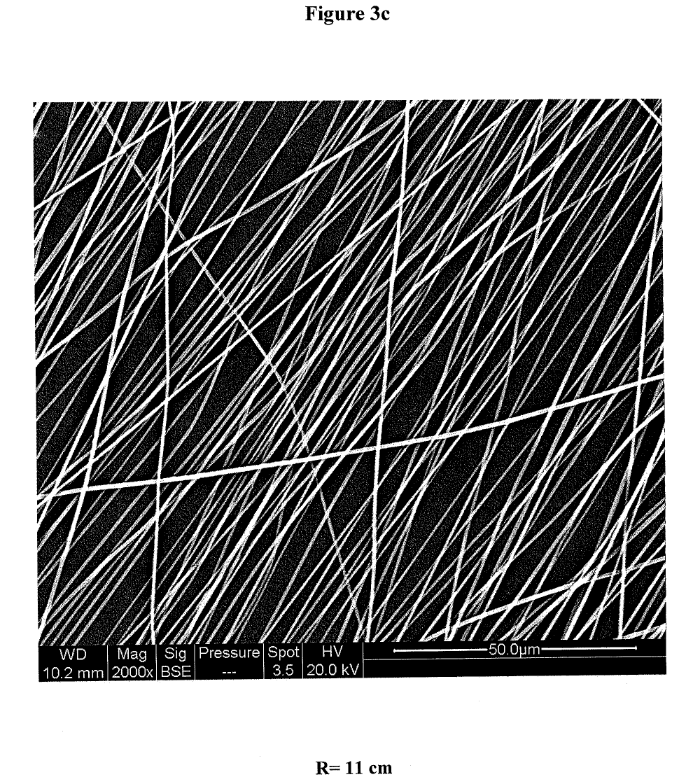

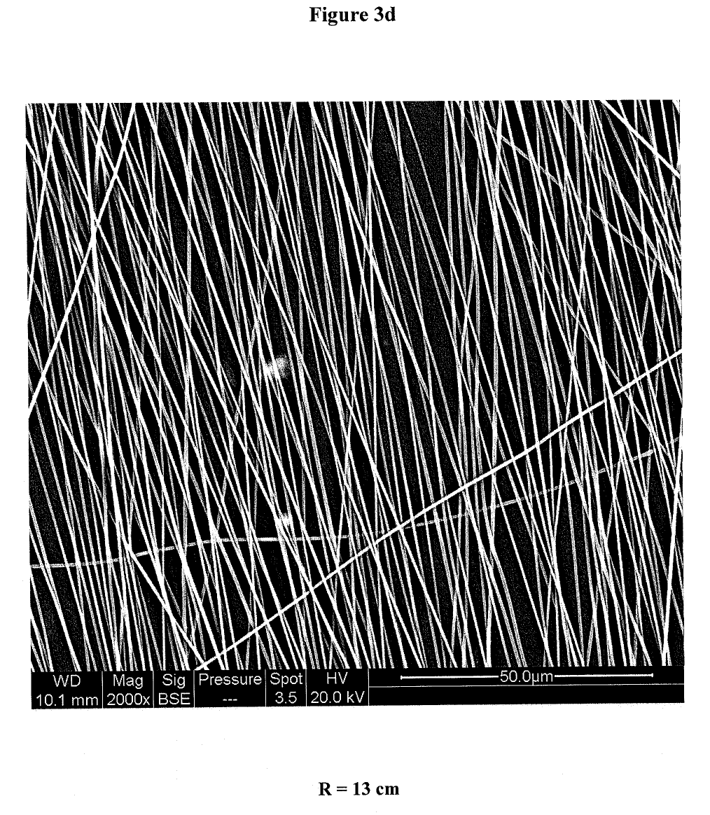

In an embodiment, the present disclosure provides an electrospinning apparatus used for alignment of nanofibers using the electric field configuration that is produced in between the electrodes of a modified electrospinning apparatus. On placing a non-conducting, thin substrate just above the focusing device that acts as anti-electrode; the electrospun nanofibers deposit on the surface of the substrate at a point directly above the needle tip of the focusing device. This is because a non-conducting substrate minimally interferes with the existing electric field configuration. Therefore, the substrate used is a thin wooden disc which is made to rotate using DC motors of different angular velocities. The axis of the DC motor is parallel to the focusing device that acts as anti-electrode. The radial distance of the point of deposition of the electrospun nanofiber on the disc along with the angular velocity of the disc defines the linear speed of the point of deposition. If the disc-motor system is now translated horizontally, nanofibers deposit at different radial distances on the disc corresponding to different substrate speeds. The electrospun nanofiber samples can be collected from different radial distances on the disc and examined under a Scanning Electron Microscope (SEM). An examination of electrospun nanofiber samples collected from different radial distances reveals the nanofiber patterns at different substrate speeds. The optimum speed can be therefore distinguished and recorded from the analysis of the above electrospun nanofiber samples. The electrospun fiber formation is dependant on the electric field used. The electric field used is one of the factors responsible for the trajectory of the charged jet of the substance that forms the nanofibers and therefore any change in its configuration alters the trajectory of the jet. In the present disclosure, the conventional flat plate metallic anti-electrode used for electrospinning is replaced with a metallic needle focusing device such as aligned vertically below the syringe needle; the resulting electric field configuration resembles an electric dipole as shown in FIG. 2. The sharply converging field lines near the focusing device that acts as the anti-electrode attracts and pulls the oppositely charged nanofiber loops, causing the diameter of the electrospun nanofibers to decrease continuously until converging finally at a single point which is the needle tip of the focusing device that acts as the anti-electrode. The nanofiber trajectory initially is similar to that of a conventional setup (simple point-plate electrode system) because the electric field configuration near the electrospinning tip shown in FIG. 2 is predominantly dictated by the charges closest to it, which in the present case happens to be at the syringe-needle tip. However, the focusing device that acts as the anti-electrode eventually (along the vertical length) changes the trajectory of the substance used for forming electrospun nanofibers into a converging spiral that is almost symmetrical to the upper half of the cone formed.

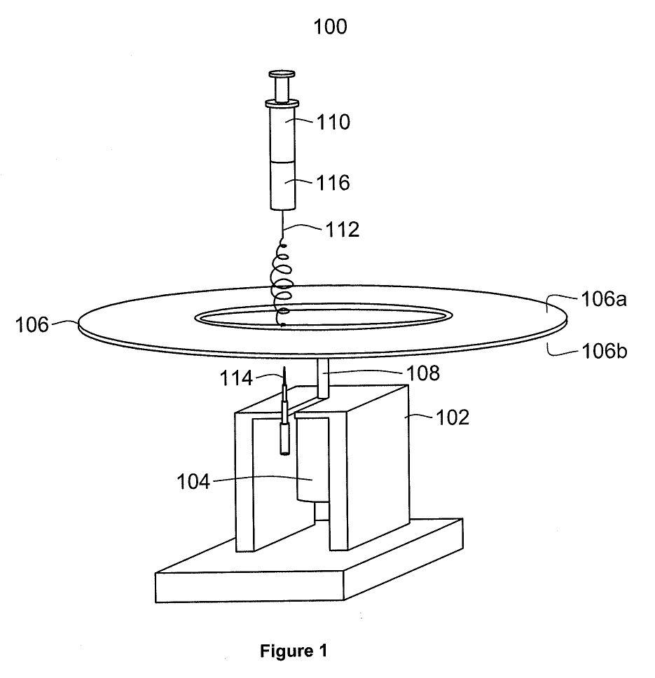

In an embodiment, the present disclosure provides the assembled electrospinning apparatus as shown in FIG. 1 used for conducting electrospinning experiments for synthesizing aligned and crossed nanofibers. Two vertical wooden slabs arranged parallel to each other are supported on a flat wooden base to form a horizontal surface. A DC motor attached to a plate kept horizontally on these vertical stands forms a table shaped structure wherein the motor is placed in between the two vertical stands. A wooden disc is attached to the shaft of this DC motor. A focusing device which in the present embodiment is a thin needle that acts as anti-electrode of the power supply is located below the disc at an appropriate distance from the center and is perpendicular to the disc surface. The plate also has a slit so that the needle can be positioned at all desirable radial distances below the collector disc. The distance between the disc surface and the needle is maintained at 0.5 cm. A syringe is clamped to a stand and the syringe needle is connected to the other electrode of the power supply, thereby acting as the electrode. This syringe-needle system is also lengthwise perpendicular to the surface of the disc and lies on the side opposite to that of the needle that acts as the anti-electrode. The syringe-needle system and the anti electrode are aligned to enable the formation of the inverted cone as shown in FIG. 2. The distance between the syringe-needle tip and the disc surface can be varied but is generally kept between 4 cm to 10 cm. A strip of non-conducting (cellophane) tape is attached on the surface of the disc for collecting fibers. The entire assembly of the electrospinning apparatus is placed inside a Plexiglas enclosure. A potential difference is applied between the two electrodes namely the electrode and the anti-electrode and the motor is switched on. The electrode setup causes an electric field configuration similar to a dipole to be generated. The polymer solution flows out to from a pendant drop at the syringe tip under the influence of gravity. As the applied potential increases, more and more charges accumulate on this drop. At a critical value of applied voltage, the electrostatic repulsions exceed the force of surface tension and a thin jet emerges from the syringe needle tip. The jet travels through the region of electric field with a net unbalanced force causing its path to become a complicated spiral. The jet thins in this region due to inter-charge repulsion and evaporation of the solvent until ultra thin polymeric nanofibers are formed. The configuration of the electric field in this particular case causes the depositing nanofibers to converge near the needle tip that acts as anti-electrode. Since, the wooden disc intercepts their path while they are converging near the anti-electrode tip; the fibers are deposited at a point on the surface of the disc directly above the anti-electrode. As the disc rotates, the fibers get collected on it in the form of a thin circular band. The cellophane tape is stripped off the disc surface and the part containing fibers is analysed using a SEM. FIG. 1 provides the different parts of the electrospinning apparatus. The electrospinning apparatus 100 for producing aligned and crossed nanofibers comprises of, a supported horizontal surface 102; a DC motor placed below the horizontal surface 104, wherein a circular rotating disc 106 is attached to the DC motor by means of shaft 108 which rotates the disc 106; said disc has two faces, namely, a top face 106a and a bottom face 106b, a reservoir 110 with an electrospinning element 112 placed perpendicularly above the disc top surface 106a, said electrospinning element 112 having at least one tip, said electrospinning element 112 having a passage by which a substance 116 from which the nanofibers are to be composed is provided to an interior of the tip of the electrospinning element 112, said electrospinning element 112 is configured to electrospin said nanofibers by electric field mediated extraction of the substance from the tip of the electrospinning element 112; and at least a focusing device 114 positioned exactly longitudinally below the electrospinning element 112 tip for focusing the electrospun nanofibers into a defined region on the disc top surface 106a. The focusing device 114 is placed below the disc bottom surface 106b and has axis perpendicular to said disc 106; said focusing device 114 is configured to focus the electrospun nanofibre by electric field.

### EXAMPLES

The following examples are put forth so as to provide those of ordinary skill in the art with a complete disclosure and the description of how to make and use the present invention, and are not intended to limit the scope of what the inventors regard as there invention nor are they intended to represent that the experiments below are all and only experiments performed.

### Example 1

Electrospun nanofibers were collected at several radial distances on the wooden disc 106 rotating at a constant angular velocity of 1500 rpm. The study was performed using 15% polystyrene solutions in tetrahydrofuran (THF) and dimethylformamide (DMF) in a ratio of 1:3. 2 ml solution placed in a reservoir 110 which is a 10 ml glass syringe fitted with a 24 gauge stainless steel needle as the electrospinning element 112. The distance between the electrospinning element 112 that acts as electrode and focusing device 114 that acts as an anti-electrode was set to 5 cm and the disc was placed 0.5 cm above the anti-electrode 114. A potential difference of 15 kV was applied between the electrode 112 and anti-electrode 114. Fibers were collected at radial distances of 7, 9, 11 and 13 cm from the center of the disc 106. A strip of cellophane tape was pasted on the disc top surface 106a and fibers were collected for duration of two minutes at each of the radial distances. The strip was then taken off and fibers collected on it were studied under a SEM.

It was observed that that the nanofiber alignment increases with increasing radial distances of the circulating disc 106 (substrate speed) as is shown in FIG. 3.

### Example 2

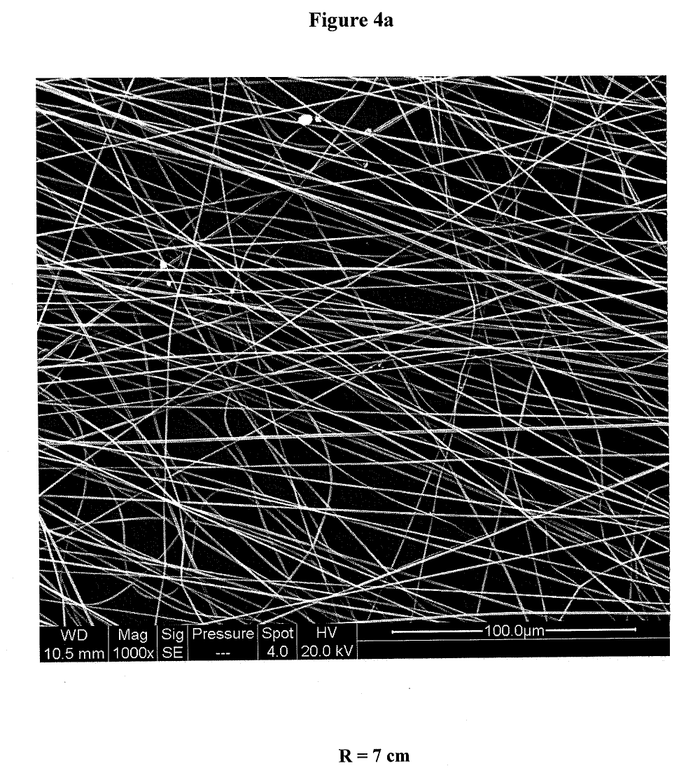

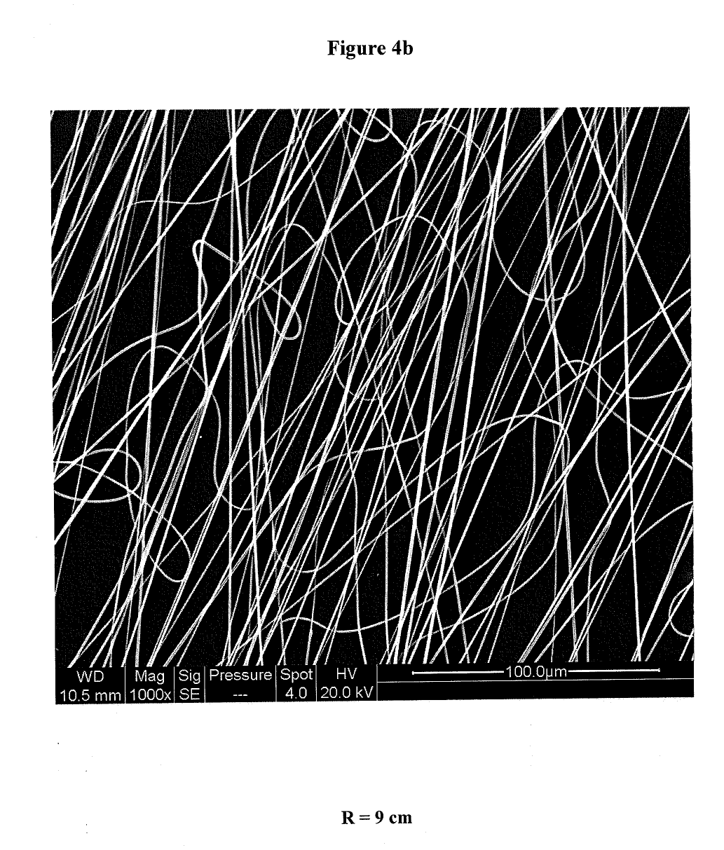

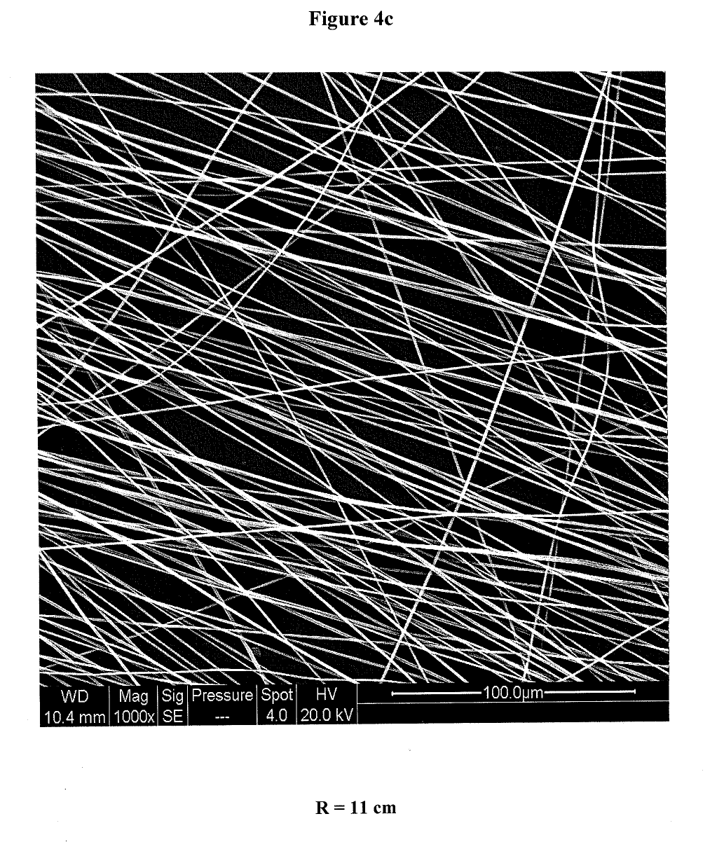

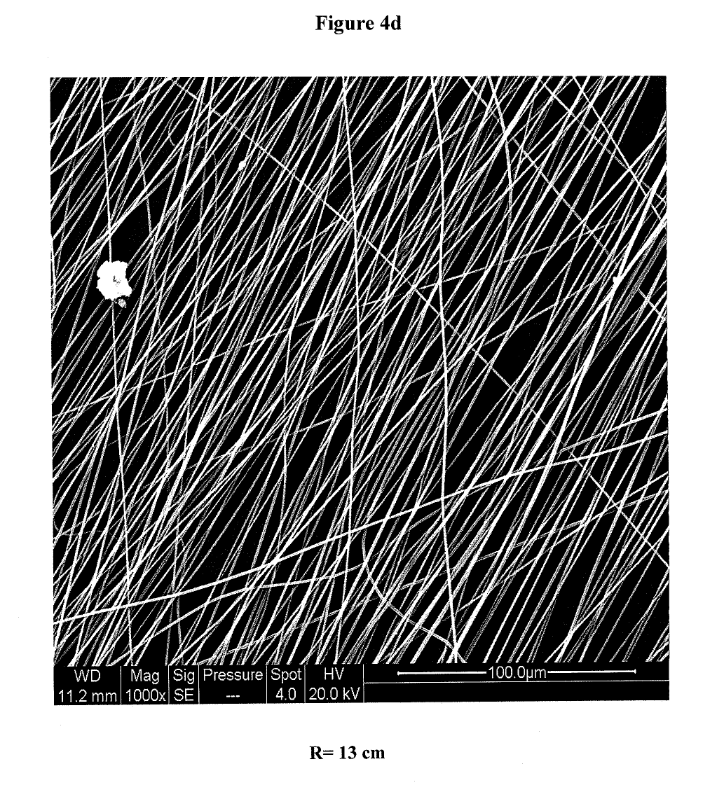

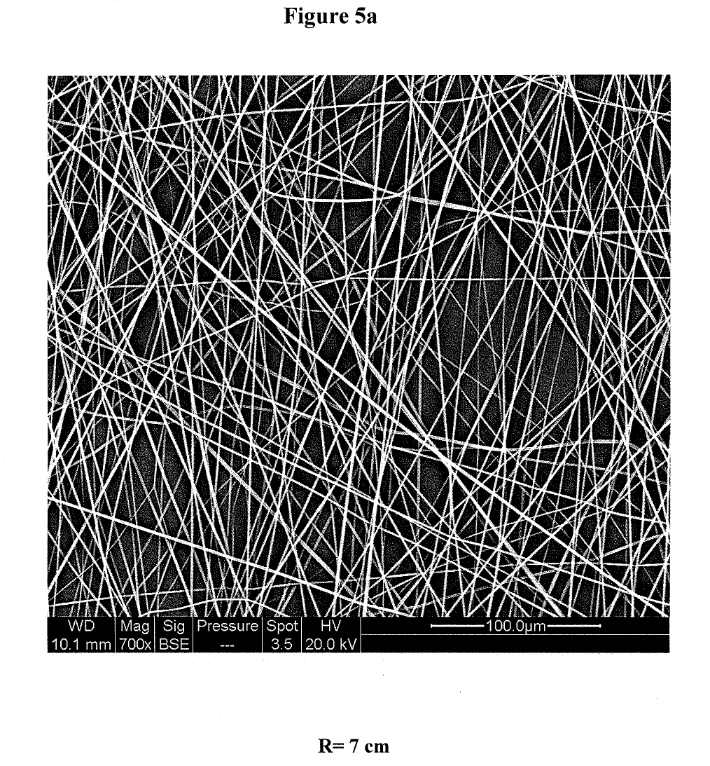

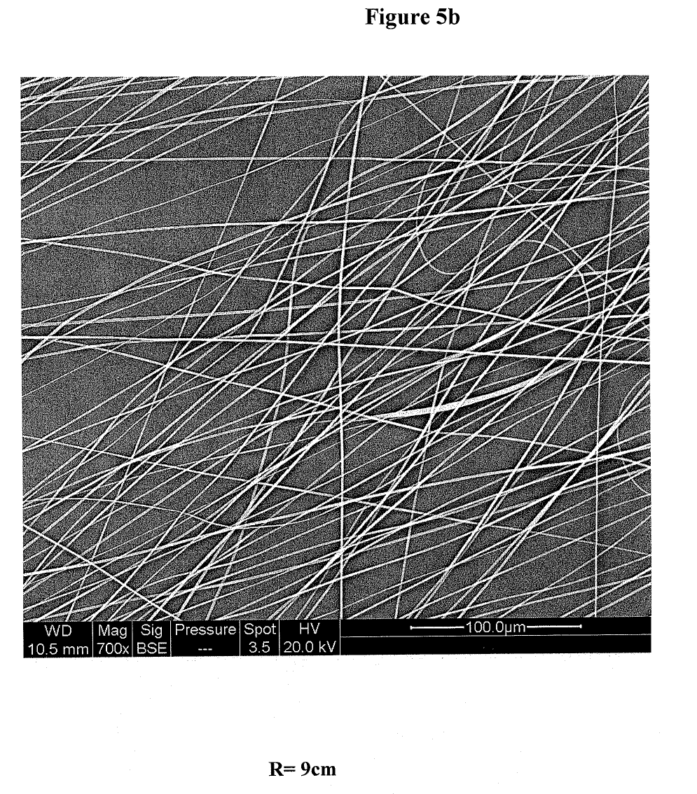

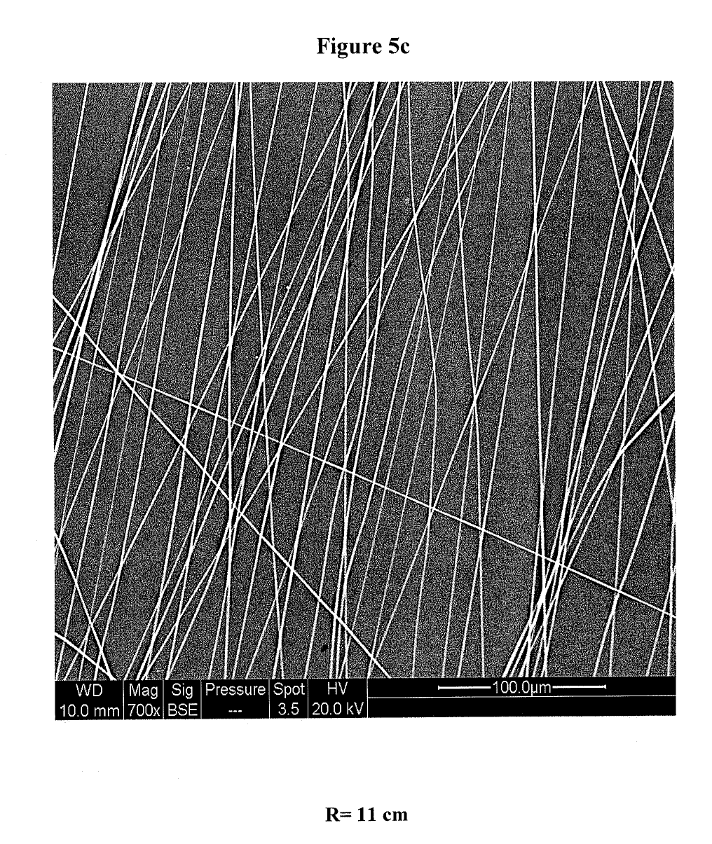

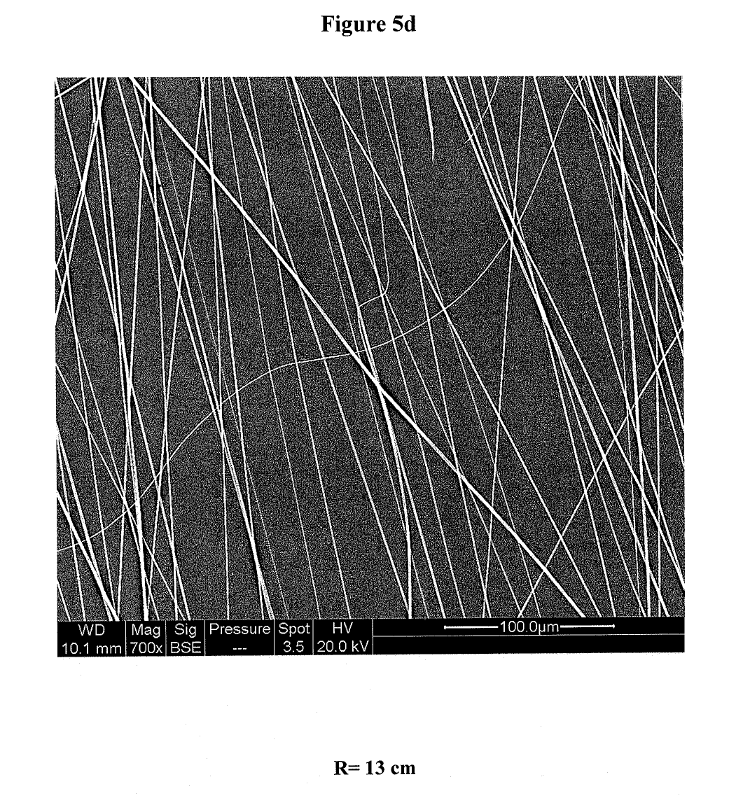

The experiment illustrated in example 1 was repeated for two more concentrations of the polymer, namely, 18% and 20% of the polystyrene solutions in tetrahydrofuran (THF) and dimethylformamide (DMF) in a ratio of 1:3 with all the other experimental parameters being the same. Similar trends for increase in fiber alignment with increasing radial distance were observed. The nanofibers formed by using 18% and 20% concentration of the polystyrene solutions are provided in FIG. 4 and FIG. 5 respectively.

### Example 3

One of the critical parameters that affect the electrospinning process is the applied potential difference between the two electrodes. Therefore, the effect of electrospinning voltage on fiber alignment was studied. The experimental set up was the same as mentioned in example 1. Different polymer concentrations were used. The voltage was varied from 7 kV to 24 kV while the electrode distance between the electrospinning element 112 that acts as an electrode and the focusing device 114 that acts as anti-electrode was maintained at 5 cm. All the fibers were collected at the radial distance of 10 cm which corresponds to a substrate speed of nearly 16 m/s. It was observed that for a given radial distance the lower voltages (in the range of 7-10 kV) give better nanofiber alignment. The nanofiber alignment decreases with increasing voltage (in the range of 10-15 V) and then shows little improvement at higher voltages (from 18 kV onwards).

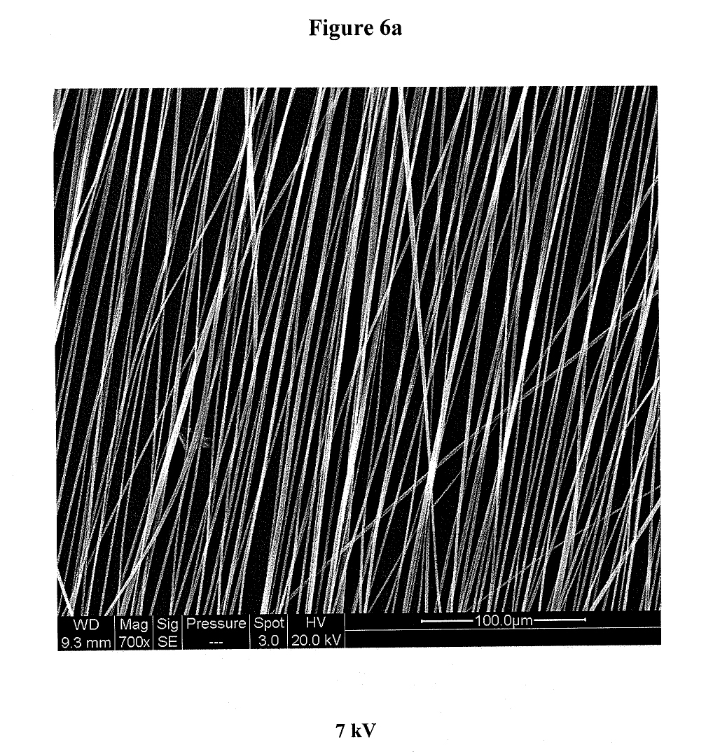

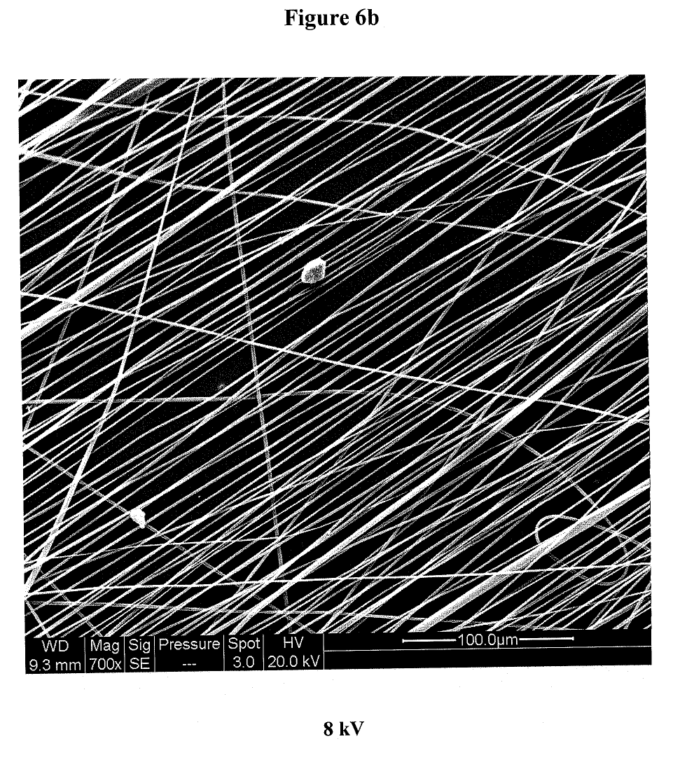

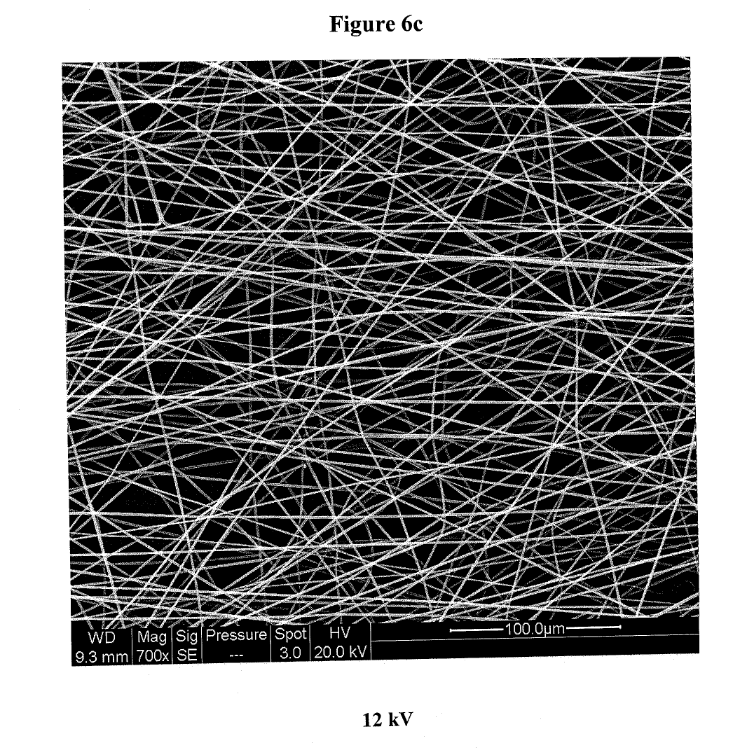

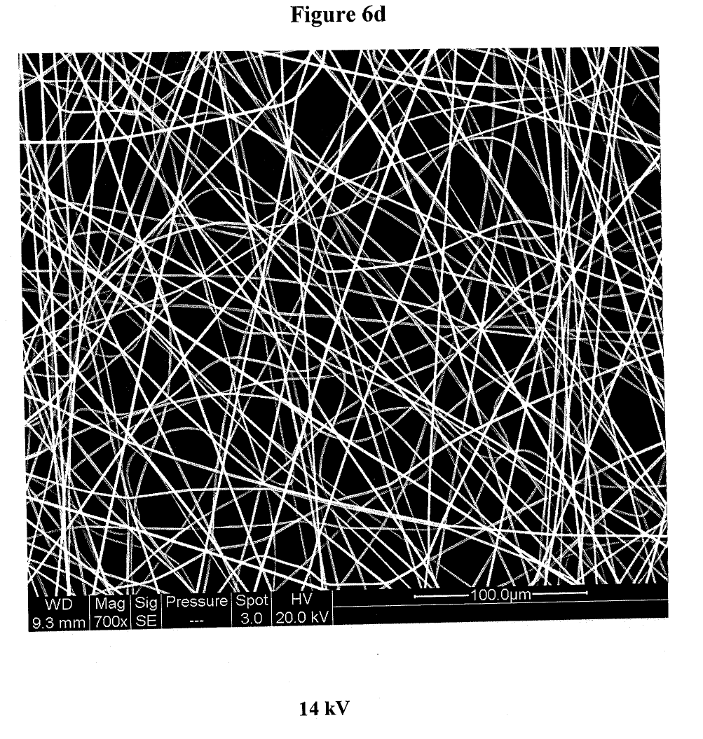

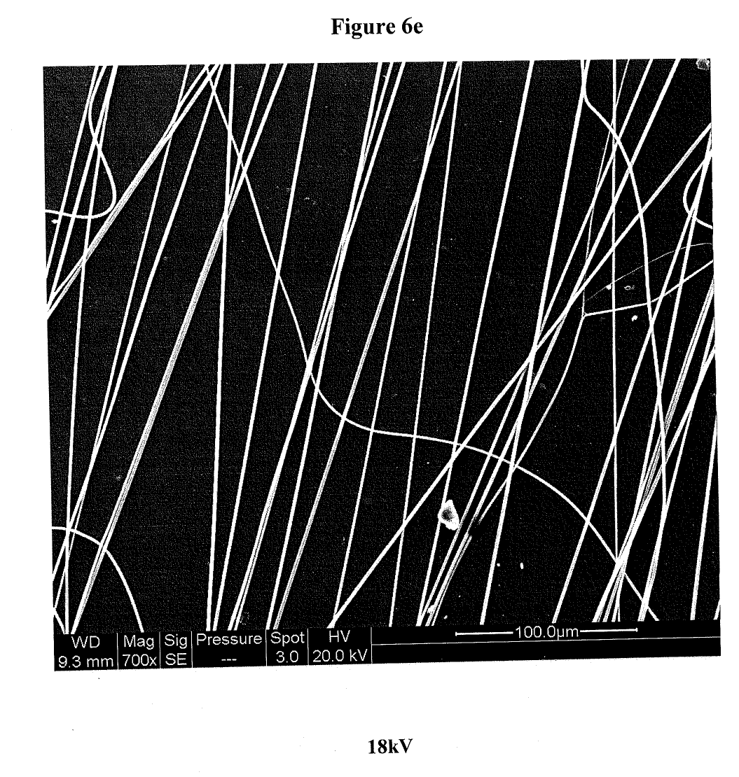

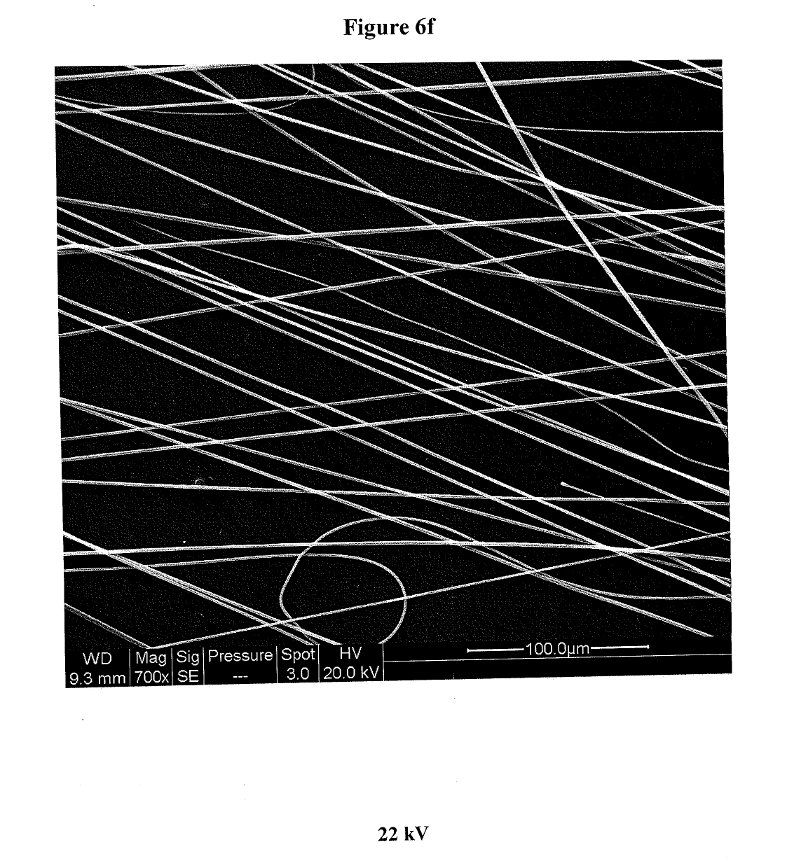

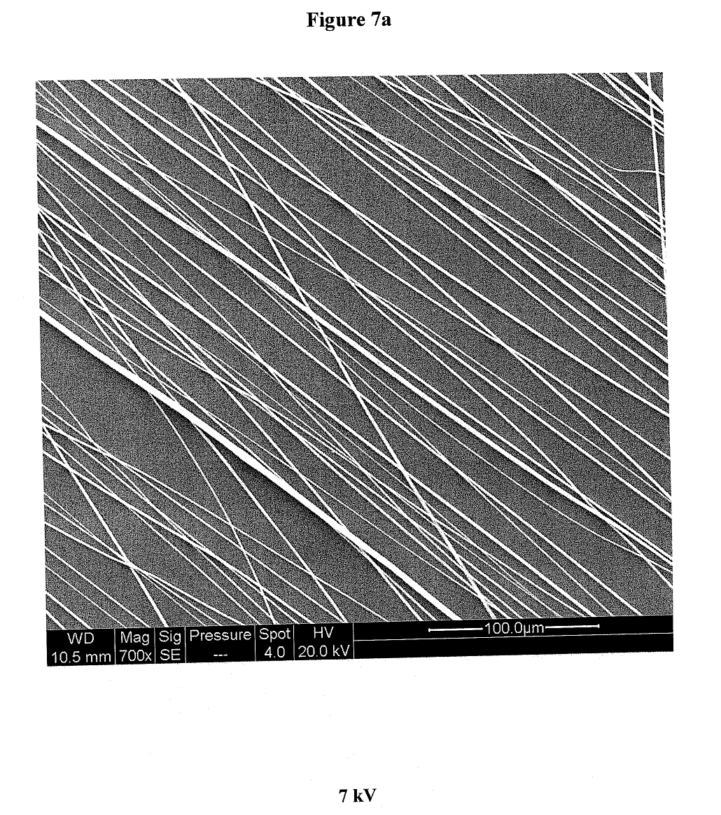

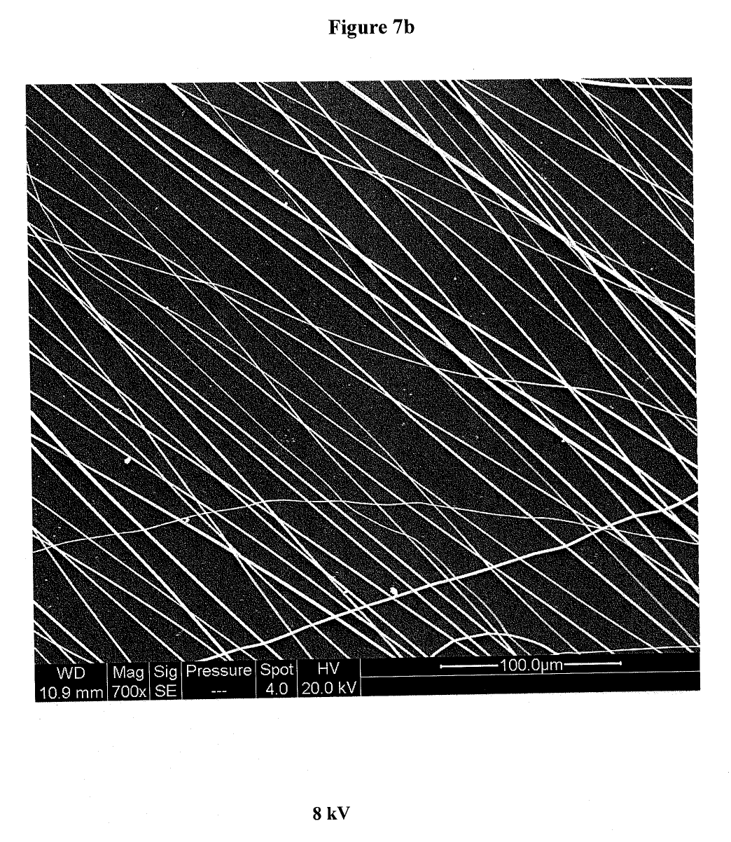

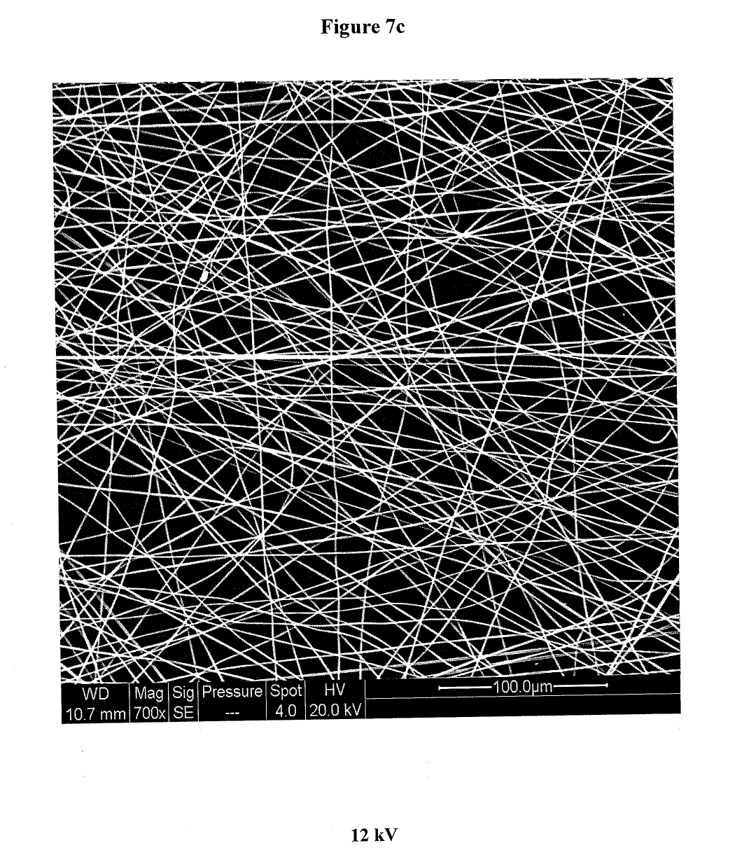

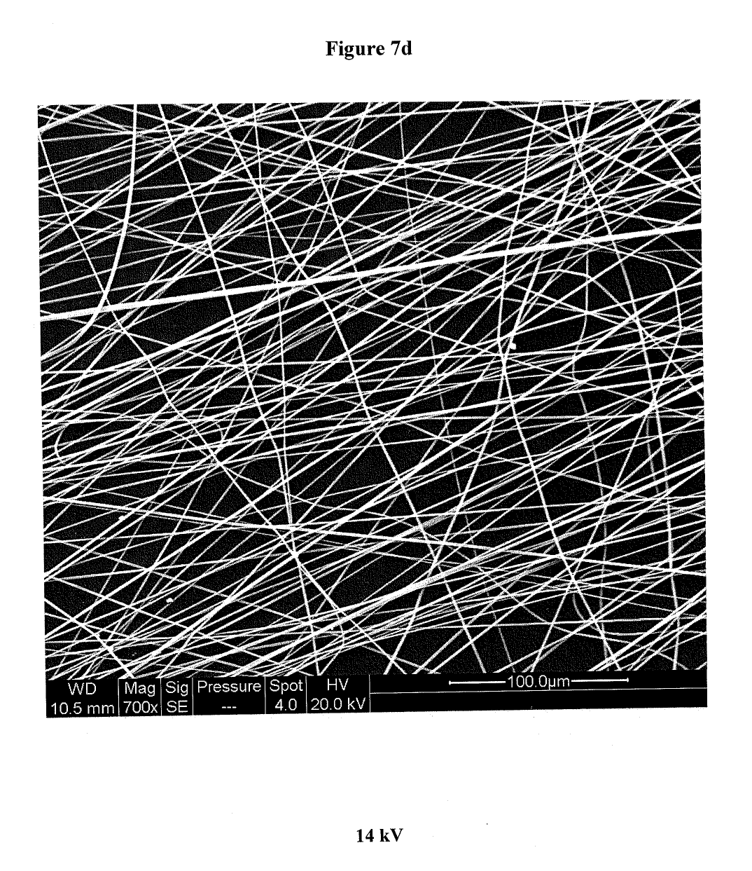

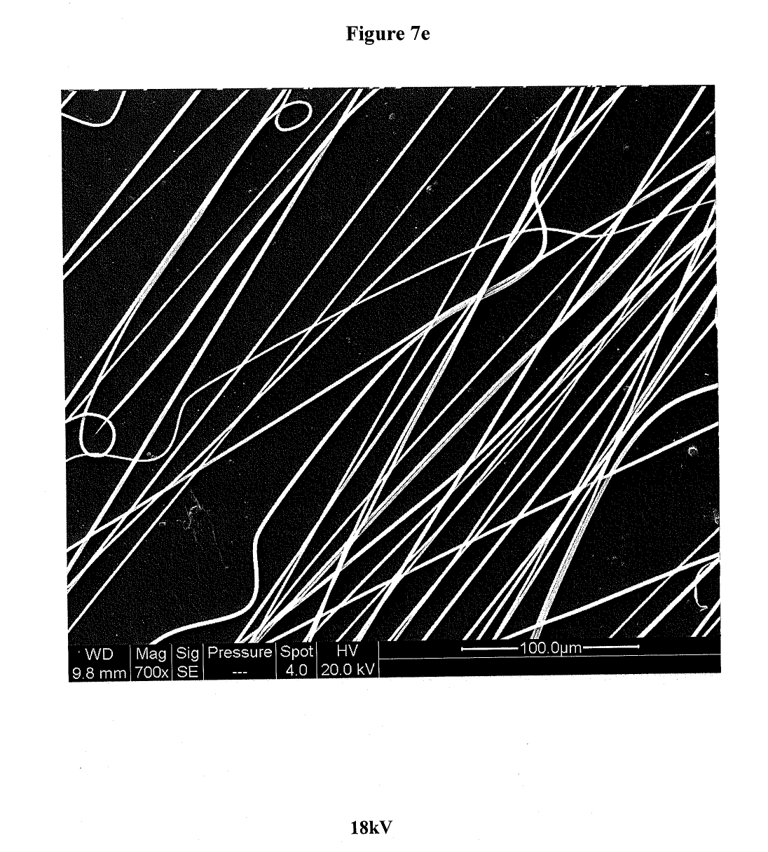

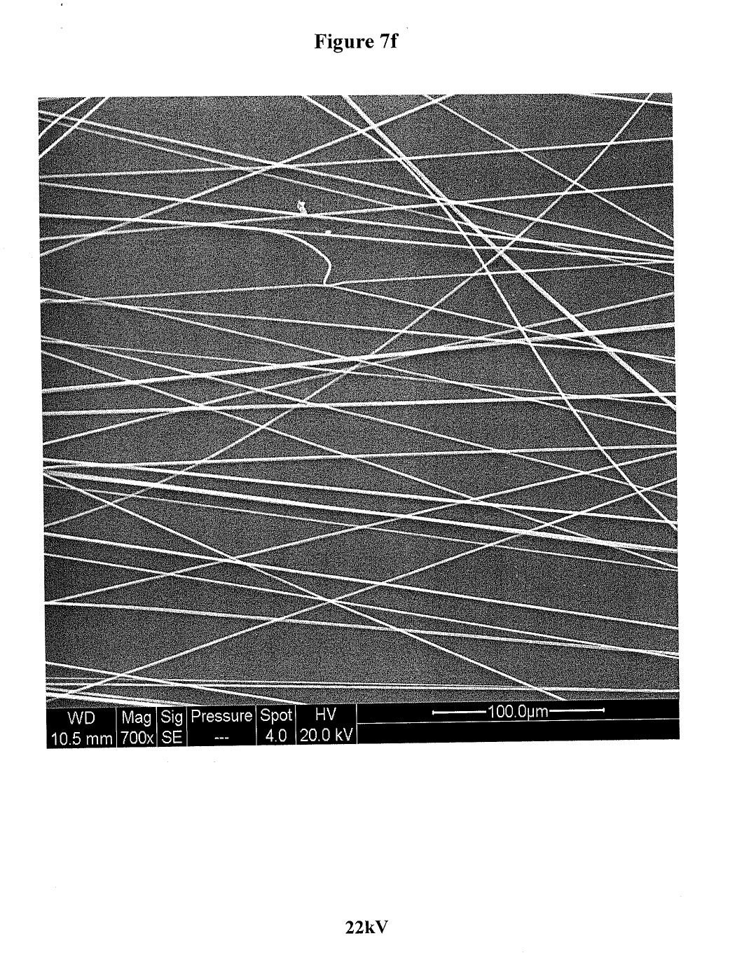

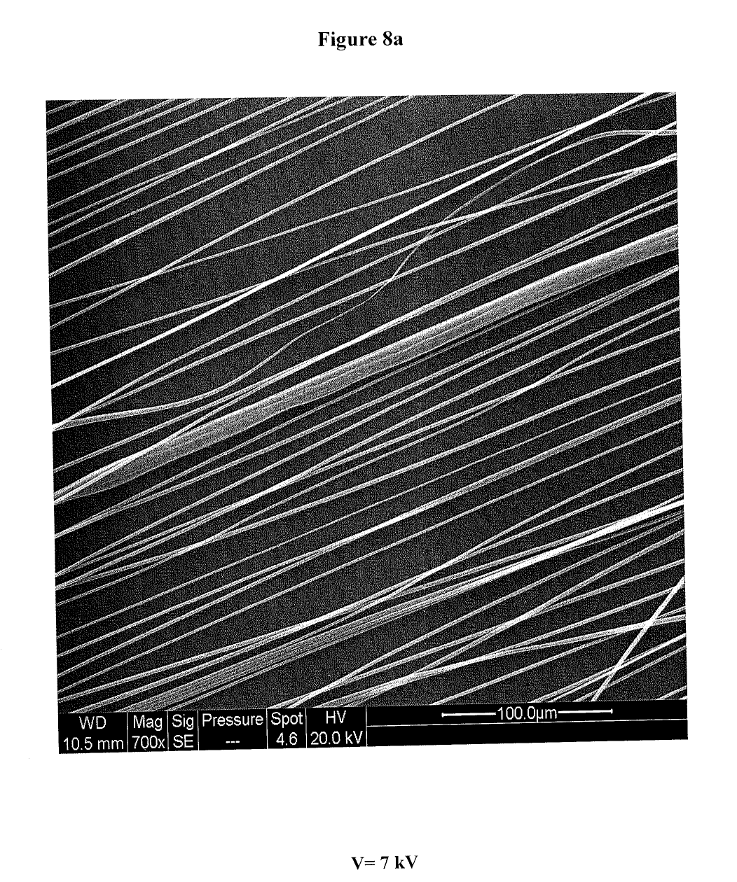

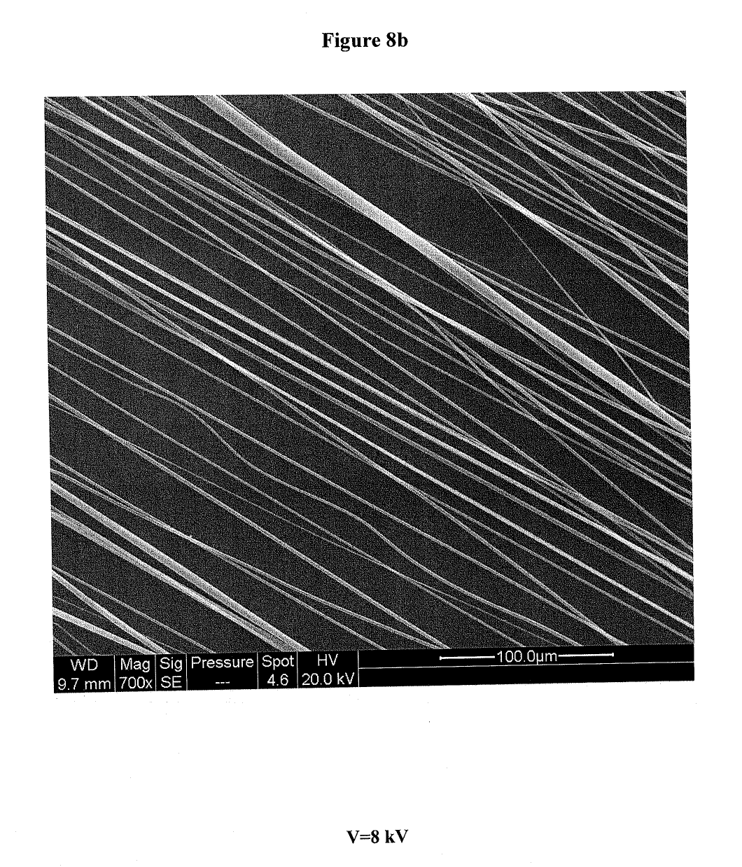

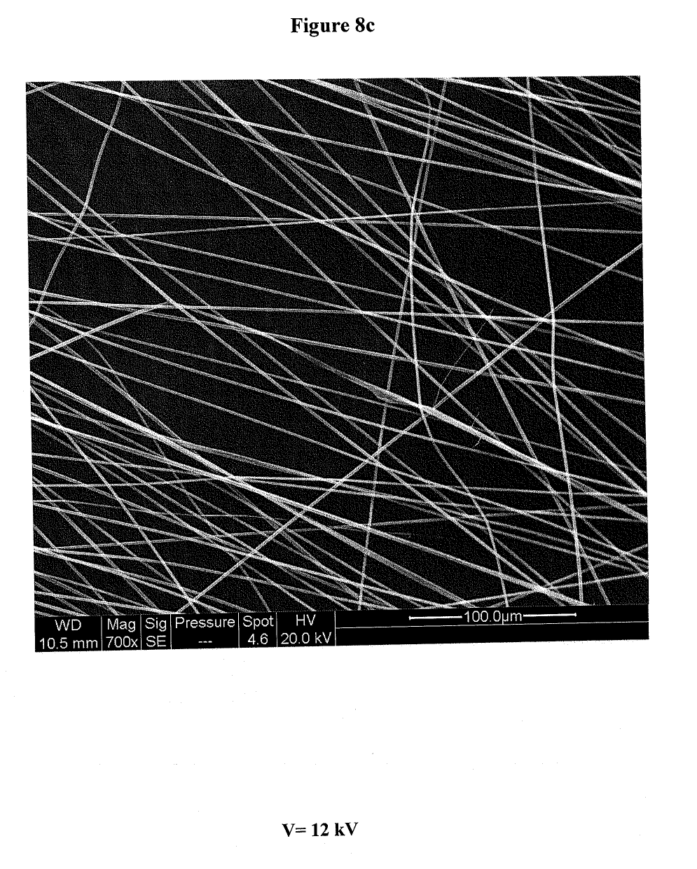

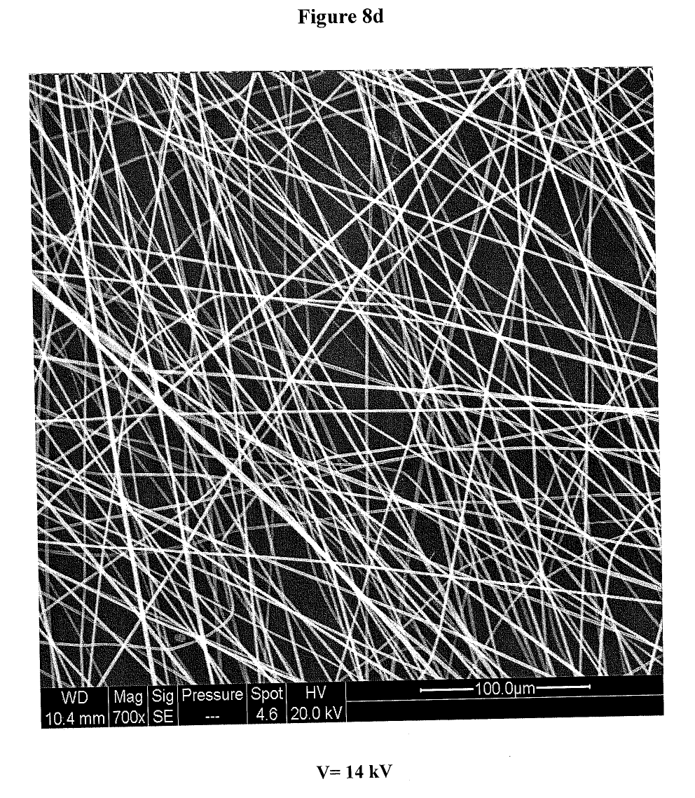

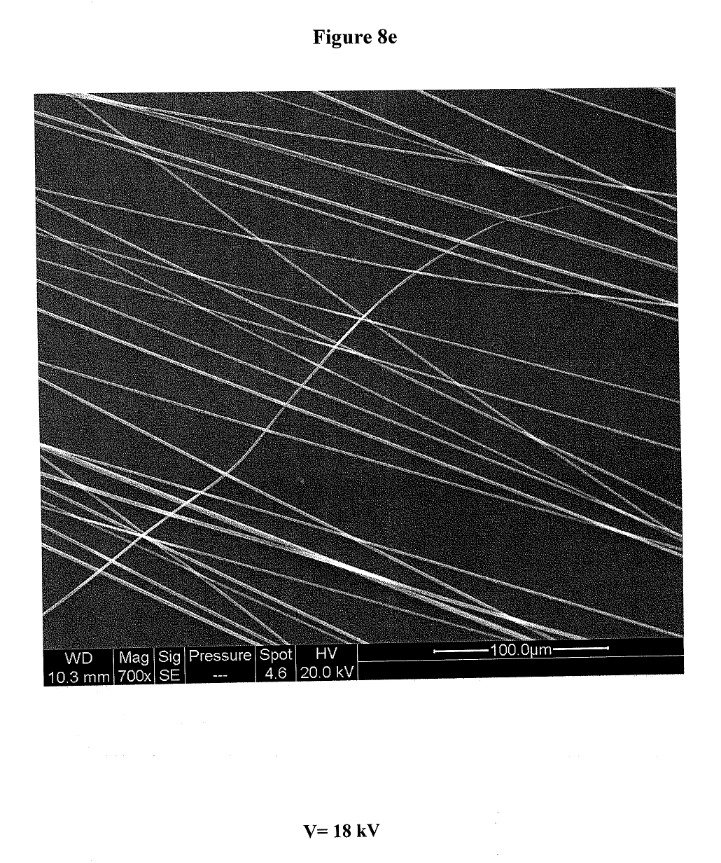

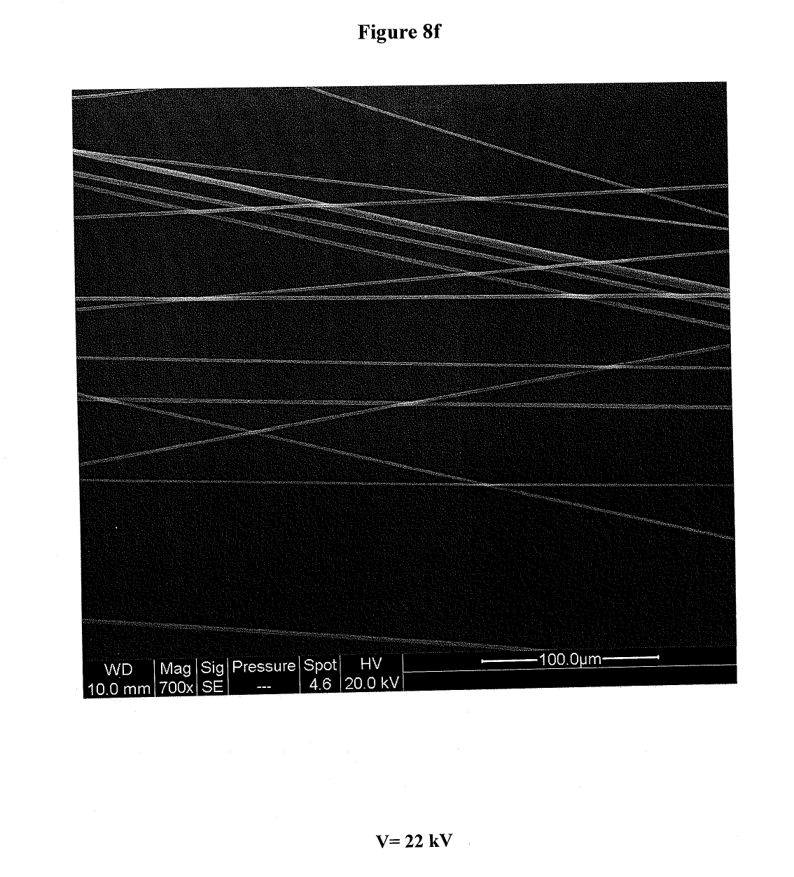

On increasing applied field for the same inter-electrode distance, the field strength increases. Due to the inherent randomness of the electrospinning process, there is always a possibility that a fiber (on account of static charges on its surface) may tend to deflect out of the converging field configuration. In such cases, when the jet of substance used to form the nanofibers have just initiated, the high field may augment its escape and later it may not be possible for it to re-enter the converging envelope cone thereby getting deposited as a random fiber. This contributes to a decreased degree of alignment at higher voltages of 12-14 kV when compared to 7-8 kV. At higher field strengths like 4-5 kV/cm, the field becomes so intense that the focusing action of electric field becomes very strong and so very few fibers tend to move out of the converging envelope cone thereby causing an improvement in the alignment pattern. However, the possibility of random perturbation is always there and therefore though the alignment tends to increase at very high fields; it does not become as good as it is at low electric fields. The results of these set of experiments using different polymer concentrations of 15%, 18% and 20% are shown in FIGS. 6, 7 and 8 respectively.

### Example 4

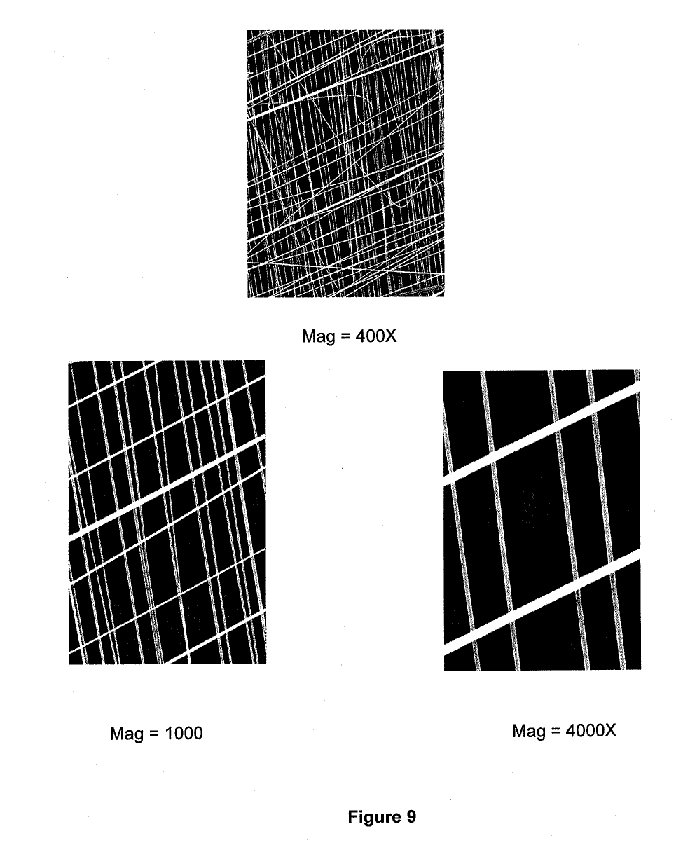

Cross fibers (a layer of aligned fibers oriented perpendicular on top of another aligned fiber layer) were also fabricated using the electrospinning apparatus 100 of the present disclosure. 15% polystyrene solution 116 was made in a solvent of tetrahydrofuran (THF) and dimethylformamide (DMF) in the ratio of 1:3 was taken in a glass syringe 110. Aligned fibers were collected at a radial distance of 13 cm on a cellophane tape on the disc top surface 106a of the electrospinning apparatus 100. The cellophane tape strip was then removed and placed perpendicular (rotated by 90°) to its previous orientation to collect another layer of aligned fibers on it. The crossed nanofibers formed from this procedure are provides in FIG. 9.

All the experiments mentioned above were conducted using polystyrene. However, the technique is not limited to polystyrene and can be extended to other polymeric systems (homopolymers, copolymers and polymeric blends) as well. A wooden rotating disc 106 was used as a collector (for nanofibers) in all the above examples. However, any other material which has a low dielectric constant (close to that of wood) can also be used for the purpose. Substrate speed of the point of deposition is an important parameter for the present invention which effects fiber alignment. For a disc, the substrate speed at any point depends on the radial distance and can be estimated using the formula V=rω where ‘V’ is the substrate speed at a point on the disc, and ‘r’ is the radial distance of the point on the disc from the disc's centre and ‘ω’ represents the angular speed (the rpm of the motor in our case). As mentioned earlier, substrate speed is critical for alignment and is dependent on two factors ‘r’ and ‘ω’ where ‘r’ is determined by the point where we are collecting the fibers which in turn is determined by the size of the disc. Similarly ‘ω’ depends on the rpm of the motor 104 used. Thus to obtain a particular substrate speed we can manipulate the above two parameters and any combination of the two can be used to get the desired substrate speed.

### REFERENCES

1. Jun Kameoka, Reid Orth, Yanou Yang, David Czaplewski, Robert Mathers, Geoffrey W Coates and H G Craighead, A scanning tip electrospinning source for deposition of oriented nanofibres, Institute of Physics Publishing, Nanotechnology 14 (2003)1124-1129
2. Yu Huang, Xiangfeng Duan, Qingqiao Wei, Charles M. Lieber, Directed Assembly of One-Dimensional Nanostructures into Functional Networks, Science 26 Vol 291 January 2001 630-633
3. Peter A. Smith, Christopher D. Nordquist, Thomas N. Jackson, and Theresa S. Mayera, Benjamin R. Martin, Jeremiah Mbindyo, and Thomas E. Mallouk, Electric-field assisted assembly and alignment of metallic nanowires, Applied Physics Letters, Volume 77, Number 9 28 Aug. 2000
4. A Theron, E Zussman and A L Yarin, Electrostatic field-assisted alignment of electrospun nanofibres, Institute Of Physics Publishing, Nanotechnology 12 (2001) 384-390 PII: S0957-4484(01)25671-2, online at stacks.iop.org/Nano/12/384

What is claimed is:

1. An electrospinning apparatus 100 for producing aligned and crossed nanofibers, said apparatus comprising,
a supported horizontal surface 102;
a DC motor attached below the horizontal surface 104, wherein a circular rotating disc 106 is attached to the DC motor by means of shaft 108 which rotates said disc 106;
a reservoir 110 with an electrospinning element 112 placed perpendicularly above said disc's top surface 106a, said electrospinning element 112 having at least a tip, said electrospinning element 112 having a passage by which a substance from which the nanofibers are to be composed is provided to an interior of said tip of the electrospinning element 112, and said electrospinning element 112 configured to electrospin said nanofibers by a high voltage mediated extraction of the substance from said tip of the electrospinning element 112; and
at least a focusing device 114 positioned longitudinally below the electrospinning element 112 tip for focusing the electrospun nanofibers into a defined region on said disc's top surface 106a, wherein said focusing device 114 is placed exactly below said tip of the electrospinning element 112 and below said disc's bottom surface 106b, said focusing device 114 having axis perpendicular to said disc 106, said focusing device 114 configured to focus the electrospun nanofibre by electric field,
wherein said electrospinning element 112 and said focusing device 114 are connected to the opposite terminals of an external high voltage (DC) power supply.

2. The electrospinning apparatus 100 as claimed in claim 1, wherein the apparatus is enclosed in a plexiglas enclosure.

3. The electrospinning apparatus 100 as claimed in claim 1, wherein said reservoir 110 is a glass syringe with a glass plunger or piston-reservoir system.

4. The electrospinning apparatus 100 as claimed in claim 1, wherein said electrospinning element 112 is a blunt capillary needle with internal diameter of about 0.1 to 1 mm, preferably about 0.4 to 0.6 mm.

5. The electrospinning apparatus 100 as claimed in claim 1, wherein said electrospinning element 112 is a metallic needle.

6. The electrospinning apparatus 100 as claimed in claim 1, wherein said focusing device 114 for focusing the electrospun nanofibers is a needle.

7. The electrospinning apparatus 100 as claimed in claim 6, wherein said needle is made of metal, preferably stainless steel.

8. The electrospinning apparatus 100 as claimed in claim 1, wherein said electrospinning element 112 and said disc 106 are at a distance ranging from 4 cm to 10 cm.

9. The electrospinning apparatus 100 as claimed in claim 1, wherein said disc 106 is made of material having low dielectric constant.

10. The electrospinning apparatus 100 as claimed in claim 1, wherein said disc 106 is made of wood and having thickness ranging from about 1 mm to about 3 mm.

11. The electrospinning apparatus 100 as claimed in claim 1, wherein said disc has a radius of about 5 to 20 cm, preferably about 13 to 15 cm.

12. The electrospinning apparatus 100 as claimed in claim 1, wherein said DC motor 104 rotates said disc at speed ranging from about 1000 rpm to about 2000 rpm.

13. A method of electrospinning to produce electrospun nanofibers by employing the apparatus 100 as claimed in claim 1, said method comprising;
introducing a potential difference between an electrospinning element 112 and a focusing device 114 for focusing said electrospun nanofibers by an external high voltage (DC) power supply;
positioning a circular disc 106 in between said electrospinning element 112 and said focusing device 114 and connecting said disc to a DC motor 104 by means of shaft 108 which rotates said disc 106,
drawing a substance from which the nanofibers are to be composed from said reservoir 110 by means of said tip of the electrospinning element 112 towards said focusing device 114 for focusing the electrospun nanofibers into a defined region on said disc's top surface 106a positioned longitudinally below said electrospinning element 112 tip, said region is coated with a non-conducting substrate; and collecting said substance as electrospun nanofiber on the said region of said disc surface 106a at position exactly longitudinally above said focusing device 114, wherein said electrospun nanofiber is in aligned form, and
optionally discontinuing said power supply; rotating said non-conducting substrate by 90°; and re-introducing said power supply to obtain said aligned electrospun nanofiber on said non-conducting substrate coated over said disc surface 106a in crossed form.

14. The method as claimed in claim 13, wherein said non-conducting substrate is plastic tape.

15. The method as claimed in claim 13, wherein said aligned nanofiber forms concentric rings having fiber diameter ranging from about 800 nm to about 1200 nm.

16. The method as claimed in claim 13, wherein said potential difference ranges from 5 kV to 25 kV.

17. The method as claimed in claim 13, wherein said substance is a polymeric substance selected from a group consisting of homopolymer, copolymer and polymer blends.

18. The method as claimed in claim 13, wherein said substance is selected from a group consisting of polystyrene, poly(lactic acid), poly(lactide-co-glycolide), chitosan, gelatin, polyvinyl alcohol, polyaniline (PANI)/PEO blend, polyurethanes, polyethylene-co-vinyl acetate, polycaprolactone, PCL, polyethylene glycol, poly(ethylene-co-vinyl alcohol), chitin, collagen, collagen-PEO, silk, silk/PEO blend and hyaluronic acid.

19. The method as claimed in claim 13, wherein said defined region on the disc 106 is at a radial distance ranging from about 7 cm to about 13 cm.
